(19) United States
(12) Patent Application Publication
(10) Pub. No.: US 2025/0373830 A1
(43) Pub. Date: Dec. 4, 2025

(54) SYSTEMS AND METHODS FOR APPLYING FILM GRAIN NOISE TO SCALED VIDEO

(71) Applicant: Advanced Micro Devices, Inc., Santa Clara, CA (US)

(72) Inventors: Frederick George Walls, Fort Collins, CO (US); Jonathan Bonsor-Matthews, Milton Keynes (GB)

(73) Assignee: Advanced Micro Devices, Inc., Santa Clara, CA (US)

(21) Appl. No.: 18/194,386

(22) Filed: Mar. 31, 2023

(51) Int. Cl. H04N 19/36; H04N 19/117; H04N 19/463; H04N 19/80

(52) U.S. Cl. CPC H04N 19/36; H04N 19/117; H04N 19/463; H04N 19/80

(57) ABSTRACT

The disclosed computing device can include video scaling circuitry configured to generate scaled video data by scaling decoded video data. The computing device can also include film grain noise generation circuitry configured to generate film grain noise data based on one or more parameters included with encoded video data from which the decoded video data is generated. The computing device can further include film grain noise application circuitry configured to apply the film grain noise data to the scaled video data. Various other methods, systems, and computer-readable media are also disclosed.

### BACKGROUND

In video compression, some content includes noise either for cinematic effect or due to the processing of analog films. This impedes the possible compression, so modern codecs allow the noise to be removed prior to encoding, where instead noise is reconstructed after decoding using a model whose parameters are sent in metadata. Typically, a video decoder implementation will output images with the noise added for consumption by a downstream engine. A downstream engine will often apply scaling to the video stream, such as upscaling (e.g., video expanded to full native screen resolution) or downscaling (e.g., video shrunk to a window on a display).

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 is a block diagram of an example system for applying film grain noise to scaled video.

FIG. 2 is a block diagram of an additional example system for applying film grain noise to scaled video.

FIG. 3 is a flow diagram of an example method for applying film grain noise to scaled video.

FIG. 4 is a block diagram of example application of film grain noise to scaled video.

FIG. 5 is a block diagram of example application of film grain noise to scaled video as part of a compositor.

FIG. 6 is a block diagram of example direct application of film grain noise to scaled video.

FIG. 7 is a block diagram of example adjustment of film grain noise based on a scaling factor.

FIG. 8 is a block diagram of example resampling of film grain noise based on a scaling factor.

FIG. 9 is a block diagram of example resampling of film grain noise with a scaling process corresponding to artificial intelligence based or machine learning based super-resolution.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

The present disclosure is generally directed to systems and methods for applying film grain noise to scaled video. As mentioned, a downstream engine will often apply scaling to the video stream, such as upscaling (e.g., video expanded to full native screen resolution) or downscaling (e.g., video shrunk to a window on a display). This scaling is typically performed on the noisy images (i.e., after the addition of the film grain noise). As a result, the quality of the scaling output is reduced by the presence of noise.

In contrast, the disclosed systems and methods scale the noiseless decoded video and apply film grain noise to the scaled video. In various examples, the film grain noise can be applied directly to the scaled video, adjusted based on a scaling factor, a type of scaling (e.g., upscaling versus downscaling), etc. Various procedures for adjusting and/or applying the film grain noise can be used depending on a type of video encoding, a type of scaling, etc. The disclosed systems and methods can be adapted to select and utilize the appropriate procedures depending on the type of video encoding and/or scaling. Alternatively, disclosed techniques can be widely applicable to various types of encoded video. Advantageously, the disclosed systems and methods improve quality of scaling output.

In one example, a computing device includes video scaling circuitry configured to generate scaled video data by scaling decoded video data, film grain noise generation circuitry configured to generate film grain noise data based on one or more parameters included with encoded video data from which the decoded video data is generated, and film grain noise application circuitry configured to apply the film grain noise data to the scaled video data.

Another example can be the previously described computing device, wherein the film grain noise application circuitry is configured to apply the film grain noise data directly to the scaled video data.

Another example can be any of the previously described computing devices, wherein the film grain noise generation circuitry is configured to generate adjusted film grain noise data based on a scaling factor used to generate the scaled video data and the film grain noise application circuitry is configured to apply the adjusted film grain noise data to the scaled video data.

Another example can be any of the previously described computing devices, wherein the film grain noise application circuitry is configured to generate the adjusted film grain noise data by adjusting spatial frequency characteristics of the film grain noise data based on the scaling factor.

Another example can be any of the previously described computing devices, wherein the film grain noise application circuitry is configured to generate interpolated film grain noise data by interpolating the film grain noise data in response to upscaling of the decoded video data and apply the interpolated film grain noise data to the scaled video data.

Another example can be any of the previously described computing devices, wherein the film grain noise application circuitry is configured to interpolate the film grain noise data by at least one of up sampling the film grain noise data with a two-dimensional filter or fitting the film grain noise data to a curve.

Another example can be any of the previously described computing devices, wherein the film grain noise application circuitry is configured to generate decimated film grain noise data by decimating the film grain noise data in response to downscaling of the decoded video data and apply the decimated film grain noise data to the scaled video data.

Another example can be any of the previously described computing devices, wherein the film grain noise application circuitry is configured to decimate the film grain noise data by at least one of down sampling the film grain noise data with a two-dimensional filter or fitting the film grain noise data to a curve.

In one example, a system can include at least one physical processor and physical memory comprising computer-executable instructions that, when executed by the at least one physical processor, cause the at least one physical processor to generate scaled video data by scaling decoded video data, generate film grain noise data based on one or more parameters included with encoded video data from which the decoded video data is generated, and apply the film grain noise data to the scaled video data.

Another example can be the previously described example system, wherein the computer-executable instructions cause the at least one physical processor to generate the film grain noise data and apply the film grain noise data to the scaled video data at least in part by generating adjusted film grain noise data based on a scaling factor used to generate the scaled video data and applying the adjusted film grain noise data to the scaled video data.

Another example can be any of the previously described example systems, wherein the computer-executable instructions cause the at least one physical processor to generate the film grain noise data at least in part by adjusting spatial frequency characteristics of the film grain noise data based on the scaling factor.

Another example can be any of the previously described example systems, wherein the computer-executable instructions cause the at least one physical processor to apply the film grain noise data to the scaled video data at least in part by generating interpolated film grain noise data by interpolating the film grain noise data in response to upscaling of the decoded video data and applying the interpolated film grain noise data to the scaled video data.

Another example can be any of the previously described example systems, wherein the computer-executable instructions cause the at least one physical processor to interpolate the film grain noise data by at least one of up sampling the film grain noise data with a two-dimensional filter or fitting the film grain noise data to a curve.

Another example can be any of the previously described example systems, wherein the computer-executable instructions cause the at least one physical processor to apply the film grain noise data to the scaled video data at least in part by generating decimated film grain noise data by decimating the film grain noise data in response to downscaling of the decoded video data and applying the decimated film grain noise data to the scaled video data.

Another example can be any of the previously described example systems, wherein the computer-executable instructions cause the at least one physical processor to decimate the film grain noise data by at least one of down sampling the film grain noise data with a two-dimensional filter or fitting the film grain noise data to a curve.

In one example, a computer-implemented method includes generating, by at least one processor, scaled video data by scaling decoded video data, generating, by the at least one processor, film grain noise data based on one or more parameters included with encoded video data from which the decoded video data is generated, and applying, by the at least one processor, the film grain noise data to the scaled video data.

Another example can be the previously described example computer-implemented method, wherein generating the film grain noise data and applying the film grain noise data to the scaled video data includes generating adjusted film grain noise data based on a scaling factor used to generate the scaled video data and applying the adjusted film grain noise data to the scaled video data.

Another example can be any of the previously described example computer-implemented methods, wherein generating the film grain noise data includes adjusting spatial frequency characteristics of the film grain noise data based on the scaling factor.

Another example can be any of the previously described example computer-implemented methods, wherein applying the film grain noise data to the scaled video data includes generating interpolated film grain noise data by interpolating the film grain noise data in response to upscaling of the decoded video data and applying the interpolated film grain noise data to the scaled video data.

Another example can be any of the previously described example computer-implemented methods, wherein applying the film grain noise data to the scaled video data includes generating decimated film grain noise data by decimating the film grain noise data in response to downscaling of the decoded video data and applying the decimated film grain noise data to the scaled video data.

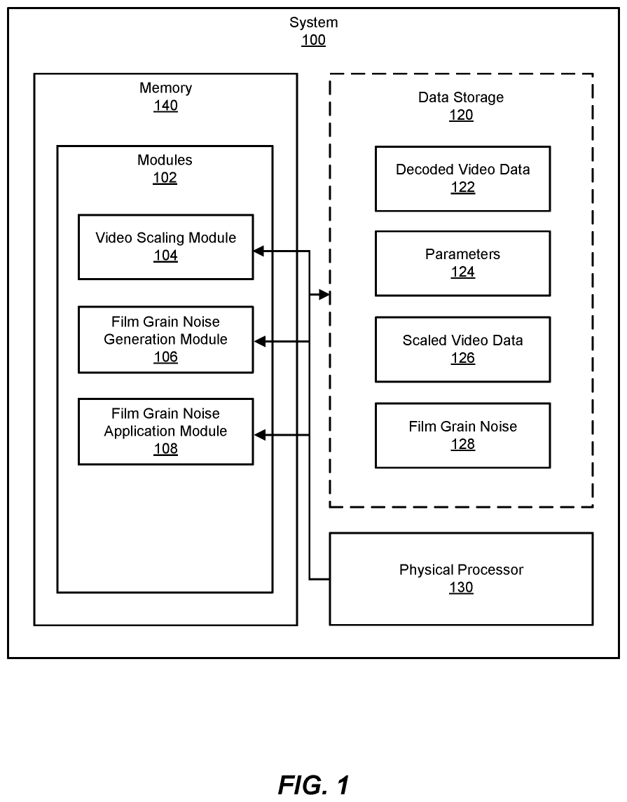

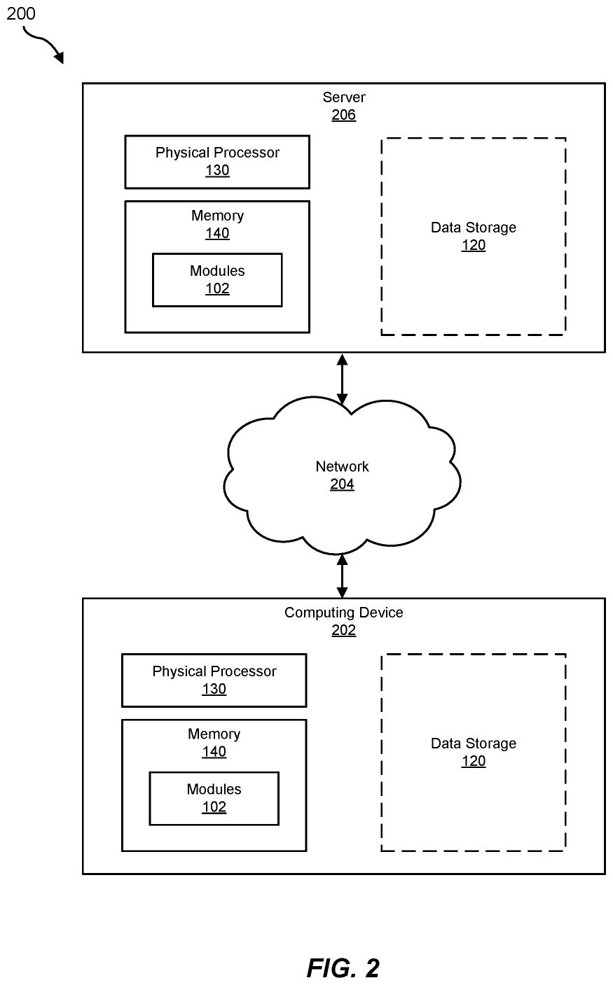

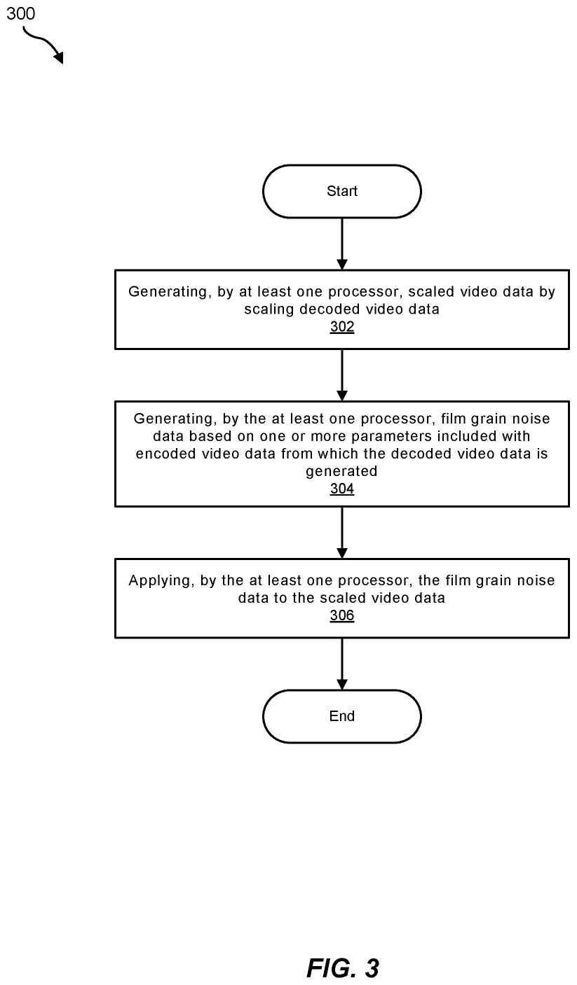

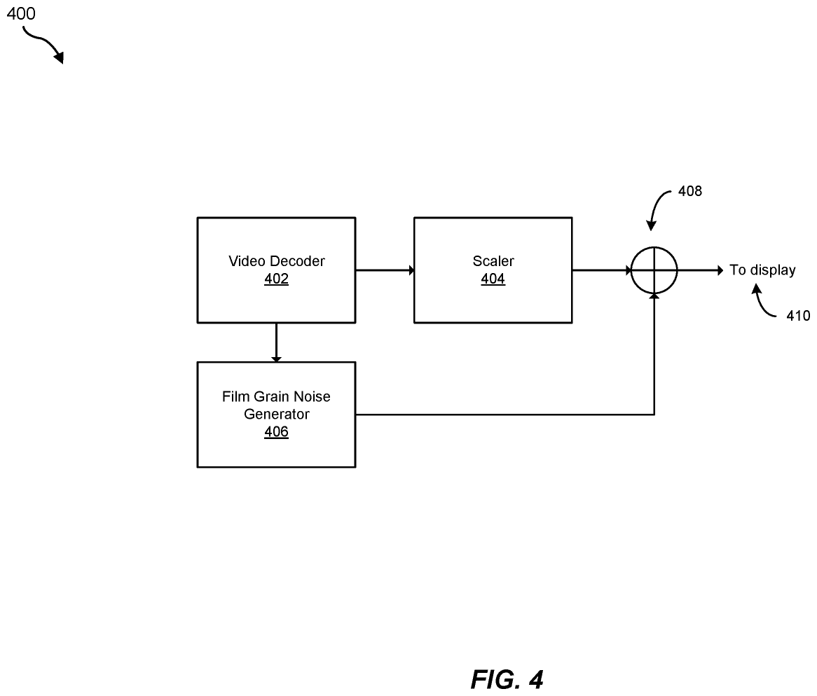

The following will provide, with reference to FIGS. 1-2, detailed descriptions of example systems for applying film grain noise to scaled video. Detailed descriptions of corresponding computer-implemented methods will also be provided in connection with FIG. 3. In addition, detailed descriptions of example applications of film grain noise to scaled video will be provided in connection with FIGS. 4-9.

FIG. 1 is a block diagram of an example system 100 for applying film grain noise to scaled video. As illustrated in this figure, example system 100 can include one or more modules 102 for performing one or more tasks. As will be explained in greater detail below, modules 102 can include a video scaling module 104, a film grain noise generation module 106, and a film grain noise application module 108. Although illustrated as separate elements, one or more of modules 102 in FIG. 1 can represent portions of a single module or application.

The term “modules,” as used herein, can generally refer to one or more functional components of a computing device. For example, and without limitation, a module or modules can correspond to hardware, software, or combinations thereof. In turn, hardware can correspond to analog circuitry, digital circuitry, communication media, or combinations thereof.

In certain implementations, one or more of modules 102 in FIG. 1 can represent one or more software applications or programs that, when executed by a computing device, can cause the computing device to perform one or more tasks. For example, and as will be described in greater detail below, one or more of modules 102 can represent modules stored and configured to run on one or more computing devices, such as the devices illustrated in FIG. 2 (e.g., computing device 202 and/or server 206). One or more of modules 102 in FIG. 1 can also represent all or portions of one or more special-purpose computers configured to perform one or more tasks.

As illustrated in FIG. 1, example system 100 can also include one or more memory devices, such as memory 140. The term “memory,” as used herein, can generally refer to any computer hardware capable of storing and/or transforming information. For example, and without limitation, a memory can correspond to hardware, software, or combinations thereof. In turn, hardware can correspond to analog circuitry, digital circuitry, communication media, or combinations thereof. Although depicted as separate from processor 130, memory 140 can be an internal memory of processor 130, a memory external to processor 130, or combinations thereof.

In certain implementations, memory 140 generally represents any type or form of volatile or non-volatile storage device or medium capable of storing data and/or computer-readable instructions. In one example, memory 140 can store, load, and/or maintain one or more of modules 102. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

As illustrated in FIG. 1, example system 100 can also include one or more physical processors, such as physical processor 130. Physical processor 130 generally represents any type or form of hardware-implemented processing unit capable of interpreting and/or executing computer-readable instructions. In one example, physical processor 130 can access and/or modify one or more of modules 102 stored in memory 140. Additionally or alternatively, physical processor 130 can execute one or more of modules 102 to facilitate applying film grain noise to scaled video. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

As illustrated in FIG. 1, example system 100 can also include one or more instances of stored data, such as data storage 120. Data storage 120 generally represents any type or form of stored data, however stored (e.g., signal line transmissions, bit registers, flip flops, software in rewritable memory, configurable hardware states, combinations thereof, etc.). In one example, data storage 120 includes databases, spreadsheets, tables, lists, matrices, trees, or any other type of data structure. Although depicted as separate from processor 130 and memory 140, data storage 120 can, in whole or in part, be included in processor 130 and/or memory 140. Examples of data storage 120 include, without limitation, decoded video data 122, parameters 124, scaled video data 126, and film grain noise 128.

Example system 100 in FIG. 1 can be implemented in a variety of ways. For example, all or a portion of example system 100 can represent portions of example system 200 in FIG. 2. As shown in FIG. 2, system 200 can include a computing device 202 in communication with a server 206 via a network 204. In one example, all or a portion of the functionality of modules 102 can be performed by computing device 202, server 206, and/or any other suitable computing system. As will be described in greater detail below, one or more of modules 102 from FIG. 1 can, when executed by at least one processor of computing device 202 and/or server 206, enable computing device 202 and/or server 206 to apply film grain noise to scaled video.

Computing device 202 generally represents any type or form of computing device capable of reading computer-executable instructions. In some implementations, computing device 202 can be and/or include a video decoder, a graphics processing unit (GPU), etc. Additional examples of computing device 202 include, without limitation, laptops, tablets, desktops, servers, cellular phones, Personal Digital Assistants (PDAs), multimedia players, embedded systems, wearable devices (e.g., smart watches, smart glasses, etc.), smart vehicles, so-called Internet-of-Things devices (e.g., smart appliances, etc.), gaming consoles, variations or combinations of one or more of the same, or any other suitable computing device.

Server 206 generally represents any type or form of computing device that is capable of reading computer-executable instructions. In some implementations, computing device 202 can be and/or include a video decoder, a cloud gaming server, etc. Additional examples of server 206 include, without limitation, storage servers, database servers, application servers, and/or web servers configured to run certain software applications and/or provide various storage, database, and/or web services. Although illustrated as a single entity in FIG. 2, server 206 can include and/or represent a plurality of servers that work and/or operate in conjunction with one another.

Network 204 generally represents any medium or architecture capable of facilitating communication or data transfer. In one example, network 204 can facilitate communication between computing device 202 and server 206. In this example, network 204 can facilitate communication or data transfer using wireless and/or wired connections. Examples of network 204 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, or any other suitable network.

Many other devices or subsystems can be connected to system 100 in FIG. 1 and/or system 200 in FIG. 2. Conversely, all of the components and devices illustrated in FIGS. 1 and 2 need not be present to practice the implementations described and/or illustrated herein. The devices and subsystems referenced above can also be interconnected in different ways from that shown in FIG. 2. Systems 100 and 200 can also employ any number of software, firmware, and/or hardware configurations. For example, one or more of the example implementations disclosed herein can be encoded as a computer program (also referred to as computer software, software applications, computer-readable instructions, and/or computer control logic) on a computer-readable medium.

The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

FIG. 3 is a flow diagram of an example computer-implemented method 300 for applying film grain noise to scaled video. The steps shown in FIG. 3 can be performed by any suitable computer-executable code and/or computing system, including system 100 in FIG. 1, system 200 in FIG. 2, and/or variations or combinations of one or more of the same. In one example, each of the steps shown in FIG. 3 can represent an algorithm whose structure includes and/or is represented by multiple sub-steps, examples of which will be provided in greater detail below.

The term “computer-implemented method,” as used herein, can generally refer to a method performed by hardware or a combination of hardware and software. For example, hardware can correspond to analog circuitry, digital circuitry, communication media, or combinations thereof. In some implementations, hardware can correspond to digital and/or analog circuitry arranged to carry out one or more portions of the computer-implemented method. In some implementations, hardware can correspond to physical processor 130 of FIG. 1. Additionally, software can correspond to software applications or programs that, when executed by the hardware, can cause the hardware to perform one or more tasks that carry out one or more portions of the computer-implemented method. In some implementations, software can correspond to one or more of modules 102 stored in memory 140 of FIG. 1.

As illustrated in FIG. 3, at step 302 one or more of the systems described herein can generate scaled video data. For example, video scaling module 104 can, as part of computing device 202 in FIG. 2, generate, by at least one processor, scaled video data by scaling decoded video data.

The term “video data,” as used herein, can generally refer to any recordable form of audio-visual information in any digital or analog format. For example, and without limitation, video data can refer to a continuous analog signal, a video file or portion thereof, a reference frame, etc.

The term “decoded video data,” as used herein, can generally refer to video data that has been extracted from encoded video data. For example, video data is often encoded by compressing the video for transmission. In this context, “decoded video data” can refer to video data that has been decompressed. In some examples, the disclosed techniques can decode the video data to an extent necessary to obtain parameters that identify a film grain noise model and to extract a noiseless portion of the video data for scaling. Thus, the term “decoded video data,” as used herein, can refer to a noiseless portion of video data, such as a noiseless reference frame, extracted from decompressed video data.

The term “video scaling,” as used herein, can generally refer to changing the size and/or resolution of video data. For example, and without limitation, video scaling can refer to changing the size of a video frame to match the native resolution of a television or computer screen. Video scaling can involve converting the resolution to a higher or lower format as well as a change in aspect ratio. Types of video scaling can include upscaling and downscaling, where upscaling can include increasing resolution and aspect ratio and downscaling can include decreasing resolution and aspect ratio. In some examples, video scaling can involve increasing resolution of video data without changing aspect ratio. In some examples, video scaling can involve increasing frame rate with little or no decrease in image quality. For example, some super resolution techniques can boost framerate while delivering near-native resolution with high-quality detail.

The systems described herein can perform step 302 in a variety of ways. In one example, video scaling module 104 can, as part of computing device 202 in FIG. 2, scale noiseless decoded video data. In some examples, video scaling module 104 can, as part of computing device 202 in FIG. 2, upscale the decoded video data. In other examples, video scaling module 104 can, as part of computing device 202 in FIG. 2, downscale the decoded video data.

At step 304 one or more of the systems described herein can generate film grain noise data. For example, film grain noise generation module 106 can, as part of computing device 202 in FIG. 2, generate, by the at least one processor, film grain noise data based on one or more parameters included with encoded video data from which the decoded video data is generated.

The term “film grain noise data,” as used herein, can generally refer to data that models and/or estimates random characteristics present in analog motion picture film. For example, analog motion picture film has randomly distributed grains due to the process of exposure and development of silver-halide crystals dispersed in photographic emulsion. Digital cameras do not produce film grain, but film grain noise is often added during post-production of digitally imaged video to simulate analog films. Film grain is characterized by a high degree of randomness that makes it difficult to compress efficiently because prediction is difficult, and reconstruction of film grain requires very high bitrates. Accordingly, film grain noise is typically estimated and removed from video data for compression during encoding, and parameters based on the estimate are provided in metadata of the encoded video data. On the decoder side, these parameters can be extracted and used to estimate the film grain noise by, for example, selecting a film grain noise model of a corresponding codec used to encode and decode the video data. The estimated and/or modeled film grain noise can be added back to the decoded video data for aesthetic reasons.

The systems described herein can perform step 304 in a variety of ways. In one example, film grain noise generation module 106 can, as part of computing device 202 in FIG. 2, generate unadjusted film grain noise data. In another example, film grain noise generation module 106 can, as part of computing device 202 in FIG. 2, generate adjusted film grain noise data based on a scaling factor used to generate the scaled video data. In some examples, film grain noise generation module 106 can, as part of computing device 202 in FIG. 2, adjust spatial frequency characteristics of the film grain noise data based on the scaling factor. In various implementations, film grain noise generation module 106 can, as part of computing device 202 in FIG. 2, generate film grain noise data in parallel operation with the generation of scaled video data by video scaling module 104 at step 302.

At step 306 one or more of the systems described herein can apply the film grain noise data. For example, film grain noise application module 108 can, as part of computing device 202 in FIG. 2, apply, by the at least one processor, the film grain noise data to the scaled video data.

The systems described herein can perform step 306 in a variety of ways. In one example, film grain noise application module 108 can, as part of computing device 202 in FIG. 2, apply the unadjusted film grain noise data directly to the scaled video data. In other examples, film grain noise application module 108 can, as part of computing device 202 in FIG. 2, apply the adjusted film grain noise data to the scaled video data. In still other examples, film grain noise application module 108 can, as part of computing device 202 in FIG. 2, generate interpolated film grain noise data by interpolating the film grain noise data in response to upscaling of the decoded video data. In some of these examples, film grain noise application module 108 can, as part of computing device 202 in FIG. 2, apply the interpolated film grain noise data to the scaled video data. In some of these examples, film grain noise application module 108 can, as part of computing device 202 in FIG. 2, interpolate the film grain noise data by up sampling the film grain noise data with a two-dimensional filter and/or fitting the film grain noise data to a curve. In further examples, film grain noise application module 108 can, as part of computing device 202 in FIG. 2, generate decimated film grain noise data by decimating the film grain noise data in response to downscaling of the decoded video data. In some of these examples, film grain noise application module 108 can, as part of computing device 202 in FIG. 2, apply the decimated film grain noise data to the scaled video data. In some of these examples, film grain noise application module 108 can, as part of computing device 202 in FIG. 2, decimate the film grain noise data by down sampling the film grain noise data with a two-dimensional filter and/or fitting the film grain noise data to a curve. In various implementations, film grain noise application module 108 can, as part of computing device 202 in FIG. 2, be pipelined with video scaling module 104 and film grain noise generation module 106. For example, video scaling module 104 and film grain noise generation module 106 may be configured to operate in parallel, with film grain noise application module 108 operating immediately on pixel data as soon as it becomes available. In some implementations, film grain noise application module 108 can be configured as an add operation (e.g., with a clamp to a valid output range) and provide noisy, scaled video data to a display and/or compositor in any suitable manner, such as those detailed below in connection with FIGS. 4-9.

Referring to FIG. 4, system 400 can include a video decoder 402, a scaler 404, a film grain noise generator 406, and an add operation 408 (e.g., with a clamp to a valid output range). In operation, video decoder can decode encoded video and, instead of generating and applying film grain noise to the video data, provide the decoded video data to scaler 404 and noise estimation parameters to film grain noise generator 406. In turn, scaler 404 can generate scaled video data by any suitable scaling technique and film grain noise generator 406 can generate film grain noise data based on the noise parameters in a same or similar manner to that employed by video decoders. Add operation 408 can combine the scaled video data and the film grain noise data, providing noisy video data to a display at 410.

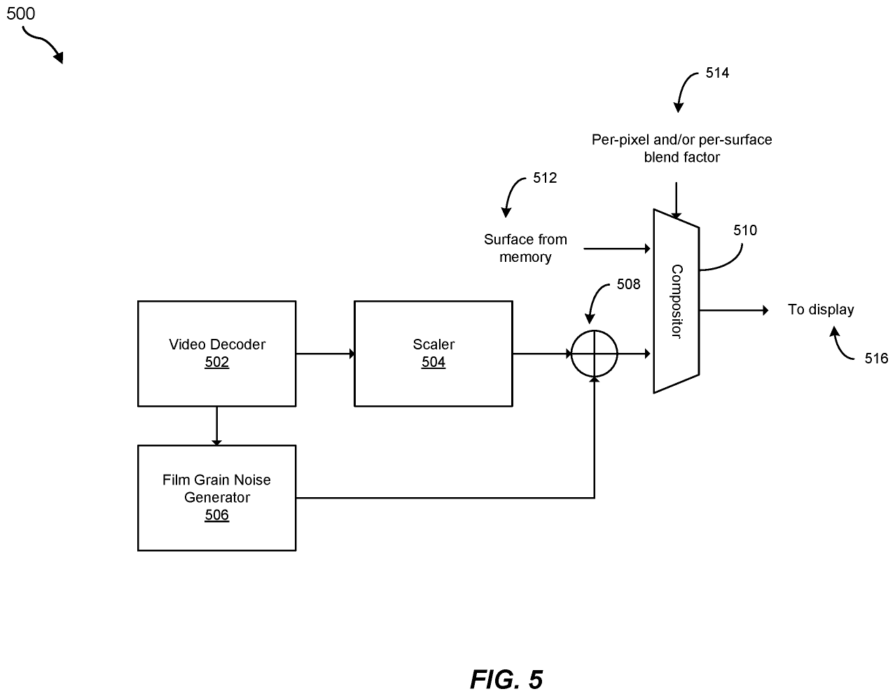

Referring to FIG. 5, system 500 can include a video decoder 502, a scaler 504, a film grain noise generator 506, and an add operation 508 (e.g., with a clamp to a valid output range) that function in a same or similar manner to that described above in connection with FIG. 4. However, instead of providing output video data to a display, add operation 508 can provide noisy video data to a compositor 510 that creates the final image of a frame, shot, or sequence. Compositors take different digital elements, like the animations, background plates, graphics, and special effects (SFX), and put them together to create a believable picture. Compositor 510, for example, can combine the noisy video data with a surface from memory 512 and/or a per-pixel and/or per-surface blend factor 514, providing output video data to a display at 516.

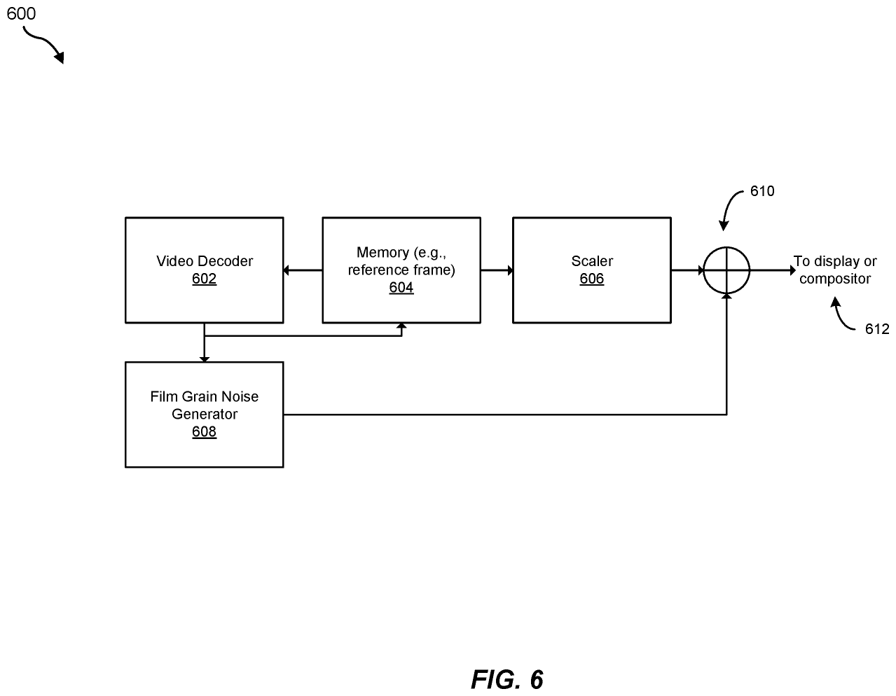

Referring to FIG. 6, system 600 can apply film grain noise data directly to scaled video data. For example, video decoder 602 can take a reference frame from memory 604, decode the reference frame, and store the decoded reference frame in memory 604 without adding film grain noise to the reference frame. Video decoder 602 can also provide noise estimation parameters of the reference frame to film grain noise generator 608. Scaler 606 can retrieve the decoded reference frame from memory 604 and scale it in any suitable manner, and film grain noise generator 608 can generate film grain noise data based on the noise parameters in a same or similar manner to that employed by video decoders. Add operation 610 (e.g., with a clamp to a valid output range) can combine the scaled reference frame and the film grain noise data, providing a noisy, scaled output frame to a display and/or compositor at 612.

The direct application of the film grain noise data sometimes can fail to match the creative intent when it does not generally maintain the frequency content or spatial structure of the intended noise. However, when a scaling factor is small, direct application can be advantageous due to its simple implementation and universal application across codecs. Accordingly, direct application can be default mode of operation that can be employed when a better option is not available and/or a scaling factor is below a threshold.

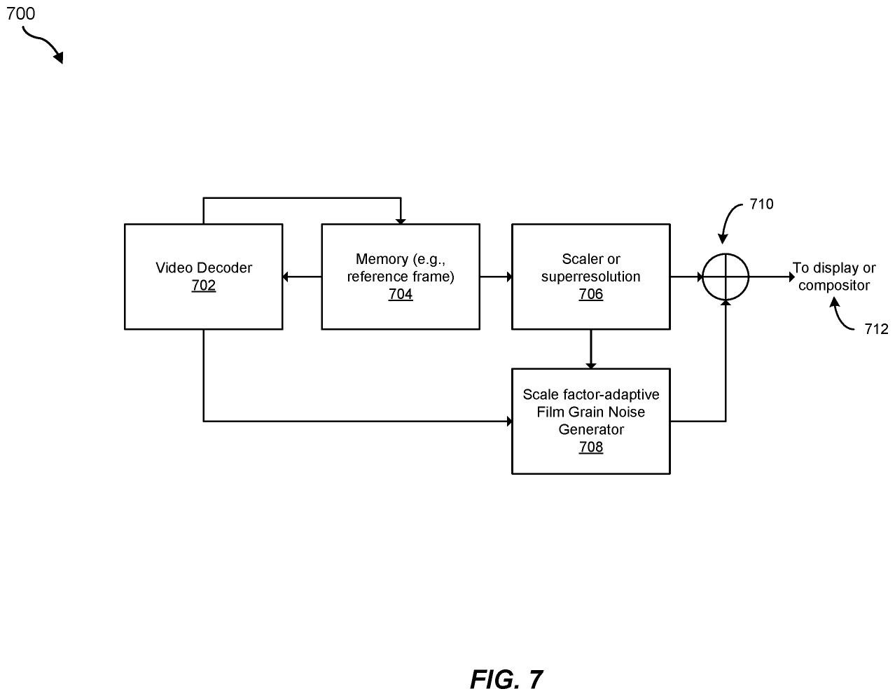

Referring to FIG. 7, system 700 can generate film grain noise data based on a scaling factor. For example, video decoder 702 can take a reference frame from memory 704, decode the reference frame, and store the decoded reference frame in memory 704 without adding film grain noise to the reference frame. Video decoder 702 can also provide noise estimation parameters of the reference frame to film grain noise generator 708. Scaler 706 can retrieve the decoded reference frame from memory 604 and scale it in any suitable manner, such as super-resolution scaling. However, instead of generating film grain noise in the same manner as that employed by video decoders, film grain noise generator 708 can adjust the film grain noise based on a scaling factor employed by scaler 706 and communicated to film grain noise generator 708 (e.g., by scaler 706). The way that film grain noise generator 708 adjusts the film grain noise based on a scaling factor can vary depending on a type of codec (e.g., AV1, AV2, AVC, VVC, HEVC, VP9, etc.), where different codecs can use different types of film grain noise models and/or estimates.

For MPEG-4 AVC using Society of Motion Picture Engineers (SMPTE) Registered Disclosure Document (RDD) five (SMPTE RDD 5) specifications, Gaussian samples can be transformed using coefficients that effectively adjust shape of the spatial frequency characteristics of the added noise. Parameters in a supplemental enhancement information (SEI) message can select the noise profile. In one example, film grain noise generator 708 can recompute coefficients of a selected noise profile based on the scaling factor of the displayed video, thus preserving spatial frequency characteristics and/or the creative intent of the noise. In an upscaling operation, film grain noise generator 708 can adjust the coefficients to attenuate higher frequencies. In a downscaling operation, film grain noise generator 708 can adjust the coefficients to preserve higher frequencies.

For AV1 film grain insertion, autoregressive coefficients can be transmitted to generate a 64×64 (or 32×32) template. In one example, film grain noise generator 708 can adjust the coefficients based on the desired scaling factor to create a template that is appropriate for the scale of the output video. In another example, film grain noise generator 708 can generate a two-dimensional (2D) patch of template samples according to the AR coefficients and scale the resulting template (e.g., to 64×64 or 32×32 or to another appropriate size) before application.

The above techniques vary depending on the type of codec, and system 700 can have a film grain noise generator 708 with multiple types of procedures for use with different codecs. Both techniques described above can have block artifact reduction to avoid the appearance of seams between adjacent blocks. Also, the overlap blending can be adjusted to take place over a wider swath of pixels in cases where the noise is mostly low frequency to reduce the appearance of block artifacts. Add operation 710 (e.g., with a clamp to a valid output range) can combine the scaled reference frame and the adjusted film grain noise data, providing a noisy, scaled output frame to a display and/or compositor at 712.

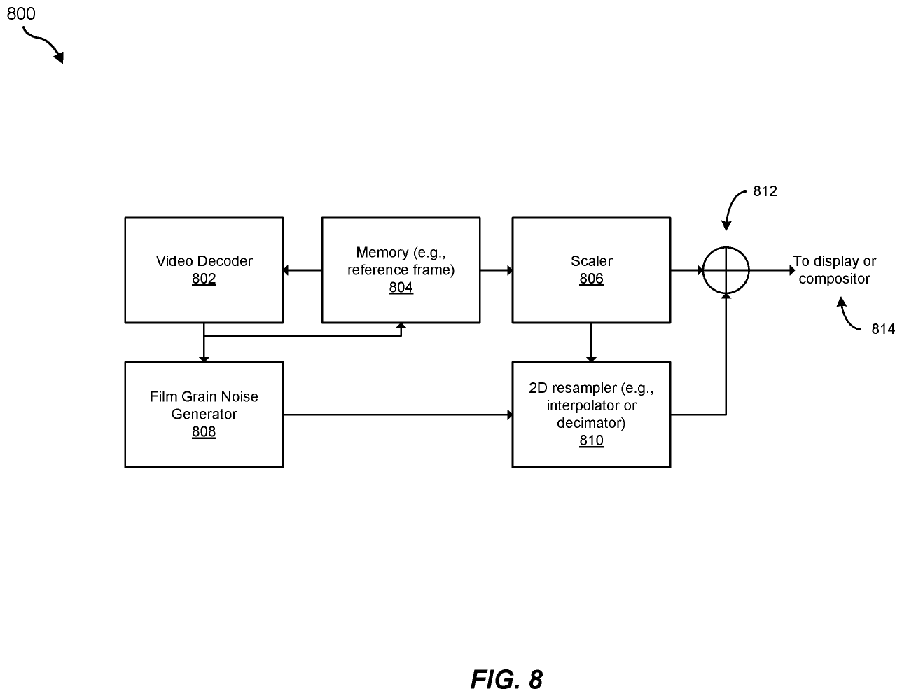

Referring to FIG. 8, system 800 can apply film grain noise data by resampling the film grain noise data. For example, video decoder 802 can take a reference frame from memory 804, decode the reference frame, and store the decoded reference frame in memory 804 without adding film grain noise to the reference frame. Video decoder 802 can also provide noise estimation parameters of the reference frame to film grain noise generator 808. Scaler 806 can retrieve the decoded reference frame from memory 804 and scale it in any suitable manner.

Film grain noise generator 808 can generate film grain noise data based on the noise parameters in a same or similar manner to that employed by video decoders. 2D resampler 810 can resample (e.g., interpolate or decimate) the film grain noise based on a scaling factor employed by scaler 806 and communicated to film grain noise generator 808 (e.g., by scaler 806). The way that 2D resampler 810 adjusts the film grain noise based on the scaling factor can vary depending on a type of scaling (e.g., upscaling, downscaling, etc.). For example, 2D resampler 810 can perform interpolation (e.g., upsampling plus 2D filter, fitting a curve, etc.) or decimation (e.g., 2D filter plus downsampling, fitting a curve/surface, etc.) to the added film grain noise based on whether the scaling applied is upscaling or downscaling, respectively. Advantageously, this technique can be applied to any film grain noise insertion technique and, thus, can be used with any codec. Add operation 812 (e.g., with a clamp to a valid output range) can combine the scaled reference frame and the adjusted film grain noise data, providing a noisy, scaled output frame to a display and/or compositor at 814.

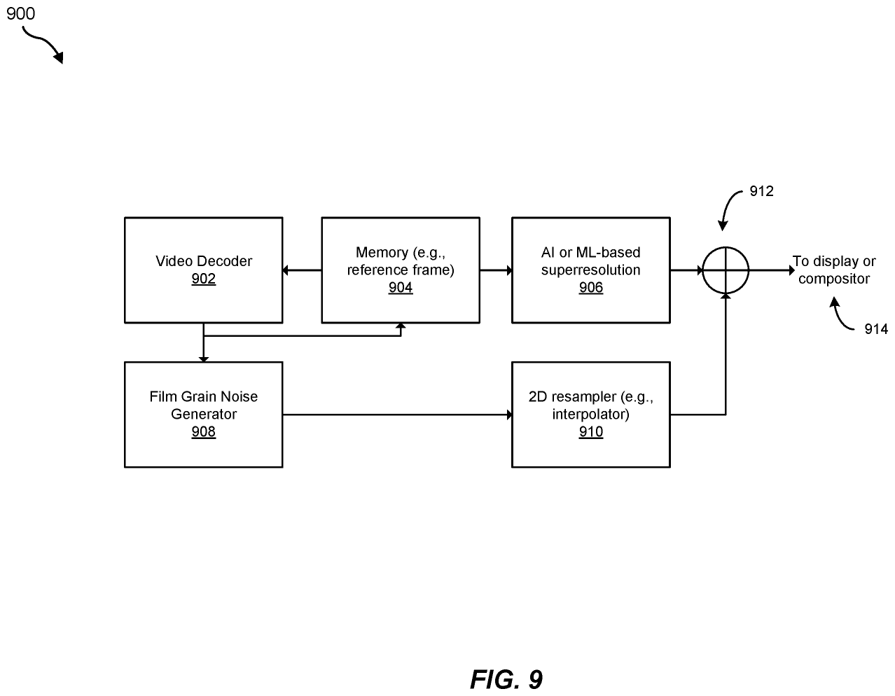

Referring to FIG. 9, system 900 can perform resampling of film grain noise as well as include a scaling process corresponding to artificial intelligence (AI) based or machine learning (ML) based super-resolution. For example, video decoder 902 can take a reference frame from memory 904, decode the reference frame, and store the decoded reference frame in memory 904 without adding film grain noise to the reference frame. Video decoder 902 can also provide noise estimation parameters of the reference frame to film grain noise generator 908. Scaler 906 can retrieve the decoded reference frame from memory 904 and scale it using Al based or ML based super-resolution. Either a conventional or AI/ML based scaler can have edge-adaptive resampling (where the filter direction and strength can be adapted based on an edge detection process on the decoded image). Film grain noise generator 908 can generate film grain noise data based on the noise parameters in a same or similar manner to that employed by video decoders. 2D resampler 910 can resample (e.g., interpolate or decimate) the film grain noise using a conventional 2D resampling or interpolation. Add operation 912 (e.g., with a clamp to a valid output range) can combine the scaled reference frame and the adjusted film grain noise data, providing a noisy, scaled output frame to a display and/or compositor at 914.

As set forth above, the disclosed systems and methods scale the noiseless decoded video and apply film grain noise to the scaled video. In various examples, the film grain noise can be applied directly to the scaled video, adjusted based on a scaling factor, a type of scaling (e.g., upscaling versus downscaling), etc. Various procedures for adjusting and/or applying the film grain noise can be used depending on a type of video encoding, a type of scaling, etc. The disclosed systems and methods can be adapted to select and utilize the appropriate procedures depending on the type of video encoding and/or scaling. Alternatively, disclosed techniques can be widely applicable to various types of encoded video. Advantageously, the disclosed systems and methods improve quality of scaling output.

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of example system 100 in FIG. 1 can represent portions of a cloud-computing or network-based environment. Cloud-computing environments can provide various services and applications via the Internet. These cloud-based services (e.g., software as a service, platform as a service, infrastructure as a service, etc.) can be accessible through a web browser or other remote interface. Various functions described herein can be provided through a remote desktop environment or any other cloud-based computing environment.

In various implementations, all or a portion of example system 100 in FIG. 1 can facilitate multi-tenancy within a cloud-based computing environment. In other words, the modules described herein can configure a computing system (e.g., a server) to facilitate multi-tenancy for one or more of the functions described herein. For example, one or more of the modules described herein can program a server to enable two or more clients (e.g., customers) to share an application that is running on the server. A server programmed in this manner can share an application, operating system, processing system, and/or storage system among multiple customers (i.e., tenants). One or more of the modules described herein can also partition data and/or configuration information of a multi-tenant application for each customer such that one customer cannot access data and/or configuration information of another customer.

According to various implementations, all or a portion of example system 100 in FIG. 1 can be implemented within a virtual environment. For example, the modules and/or data described herein can reside and/or execute within a virtual machine. As used herein, the term “virtual machine” generally refers to any operating system environment that is abstracted from computing hardware by a virtual machine manager (e.g., a hypervisor).

In some examples, all or a portion of example system 100 in FIG. 1 can represent portions of a mobile computing environment. Mobile computing environments can be implemented by a wide range of mobile computing devices, including mobile phones, tablet computers, e-book readers, personal digital assistants, wearable computing devices (e.g., computing devices with a head-mounted display, smartwatches, etc.), variations or combinations of one or more of the same, or any other suitable mobile computing devices. In some examples, mobile computing environments can have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein can be provided for a mobile computing environment and/or can interact with a mobile computing environment.

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed.

While various implementations have been described and/or illustrated herein in the context of fully functional computing systems, one or more of these example implementations can be distributed as a program product in a variety of forms, regardless of the particular type of computer-readable media used to actually carry out the distribution. The implementations disclosed herein can also be implemented using modules that perform certain tasks. These modules can include script, batch, or other executable files that can be stored on a computer-readable storage medium or in a computing system. In some implementations, these modules can configure a computing system to perform one or more of the example implementations disclosed herein.

The preceding description has been provided to enable others skilled in the art to best utilize various aspects of the example implementations disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

1. A computing device, comprising:
at least one circuit configured to:
prior to applying film grain noise data to decoded video data, scale a resolution of decoded video data;
generate film grain noise data based on information regarding the scaling of the resolution and based on one or more parameters included with encoded video data from which the decoded video data is generated; and
after scaling the resolution of the decoded video data, apply the film grain noise data to the scaled video data.

2. The computing device of claim 1, wherein the at least one circuit is further configured to:
apply the film grain noise data directly to the scaled video data.

3. The computing device of claim 1, wherein
the at least one circuit is further configured to: generate adjusted film grain noise data based on a scaling factor used to scale the resolution of the video data; and
apply the adjusted film grain noise data to the scaled video data.

4. The computing device of claim 3, wherein at least one circuit is further configured to: generate the adjusted film grain noise data by adjusting spatial frequency characteristics of the film grain noise data based on the scaling factor.

5. The computing device of claim 1, wherein the at least one circuit is further configured to:
generate interpolated film grain noise data by interpolating the film grain noise data in response to upscaling of the decoded video data; and
apply the interpolated film grain noise data to the scaled video data.

6. The computing device of claim 5, wherein the at least one circuit is further configured to interpolate the film grain noise data by at least one of:
up sampling the film grain noise data with a two-dimensional filter; or
fitting the film grain noise data to a curve.

7. The computing device of claim 1, wherein the at least one circuit is further configured to:
generate decimated film grain noise data by decimating the film grain noise data in response to downscaling of the decoded video data; and
apply the decimated film grain noise data to the scaled video data.

8. The computing device of claim 7, wherein the at least one circuit is further configured to decimate the film grain noise data by at least one of:
down sampling the film grain noise data with a two-dimensional filter; or
fitting the film grain noise data to a curve.

9. A system comprising:
at least one physical processor; and
physical memory comprising computer-executable instructions that, when executed by the at least one physical processor, cause the at least one physical processor to:
prior to applying film grain noise data to decoded video, scale a resolution of the decoded video data;
generate film grain noise data based on information regarding the scaling and based on one or more parameters included with encoded video data from which the decoded video data is generated; and
after scaling the resolution of the decoded video data, apply the film grain noise data to the scaled video data.

10. The system of claim 9, wherein the computer-executable instructions cause the at least one physical processor to generate the film grain noise data and apply the film grain noise data to the scaled video data at least in part by:
generating adjusted film grain noise data based on a scaling factor used to generate the scaled video data; and
applying the adjusted film grain noise data to the scaled video data.

11. The system of claim 10, wherein the computer-executable instructions cause the at least one physical processor to generate the film grain noise data at least in part by adjusting spatial frequency characteristics of the film grain noise data based on the scaling factor.

12. The system of claim 9, wherein the computer-executable instructions cause the at least one physical processor to apply the film grain noise data to the scaled video data at least in part by:
generating interpolated film grain noise data by interpolating the film grain noise data in response to upscaling of the decoded video data; and
applying the interpolated film grain noise data to the scaled video data.

13. The system of claim 12, wherein the computer-executable instructions cause the at least one physical processor to interpolate the film grain noise data by at least one of:
up sampling the film grain noise data with a two-dimensional filter; or
fitting the film grain noise data to a curve.

14. The system of claim 9, wherein the computer-executable instructions cause the at least one physical processor to apply the film grain noise data to the scaled video data at least in part by:
generating decimated film grain noise data by decimating the film grain noise data in response to downscaling of the decoded video data; and
applying the decimated film grain noise data to the scaled video data.

15. The system of claim 14, wherein the computer-executable instructions cause the at least one physical processor to decimate the film grain noise data by at least one of:
down sampling the film grain noise data with a two-dimensional filter; or
fitting the film grain noise data to a curve.

16. A computer-implemented method comprising:
prior to applying film grain noise data to decoded video data, scaling, by at least one processor, a resolution of the decoded video data;
generating, by the at least one processor, film grain noise data based on information regarding the scaled resolution and based on one or more parameters included with encoded video data from which the decoded video data is generated; and
applying, by the at least one processor, the film grain noise data to the scaled video data.

17. The computer-implemented method of claim 16, wherein generating the film grain noise data and applying the film grain noise data to the scaled video data includes:
generating adjusted film grain noise data based on a scaling factor used to generate the scaled video data; and
applying the adjusted film grain noise data to the scaled video data.

18. The computer-implemented method of claim 17, wherein generating the film grain noise data includes adjusting spatial frequency characteristics of the film grain noise data based on the scaling factor.

19. The computer-implemented method of claim 16, wherein applying the film grain noise data to the scaled video data includes:
generating interpolated film grain noise data by interpolating the film grain noise data in response to upscaling of the decoded video data; and
applying the interpolated film grain noise data to the scaled video data.

20. The computer-implemented method of claim 16, wherein applying the film grain noise data to the scaled video data includes:
generating decimated film grain noise data by decimating the film grain noise data in response to downscaling of the decoded video data; and
applying the decimated film grain noise data to the scaled video data.
